(19) United States
(12) Patent Application Publication
(10) Pub. No.: US 2021/0273271 A1
(43) Pub. Date: Sep. 2, 2021

(54) BATTERY SYSTEM, VEHICLE HAVING SUCH A BATTERY SYSTEM, AND METHOD FOR OPERATING A BATTERY SYSTEM

(71) Applicant: Robert Bosch GmbH, Stuttgart (DE)

(72) Inventors: Christoph Woll, Gerlingen (DE); Dierk Staebler, Oberriexingen (DE)

(21) Appl. No.: 17/188,853

(22) Filed: Mar. 1, 2021

(30) Foreign Application Priority Data
Mar. 2, 2020 (DE) 10 2020 202 643.2

(51) Int. Cl. H01M 10/48; H01M 50/249; H01M 50/207; H01M 10/42; H01M 50/51; H01M 50/512

(52) U.S. Cl. CPC H01M 10/482; H01M 50/249; H01M 50/207; H01M 2220/20; H01M 50/51; H01M 50/512; H01M 10/425

(57) ABSTRACT

A battery system comprising a plurality of battery modules which can be electrically connected in series and/or in parallel with one another in a circuit of the battery system and each have a plurality of battery cells which are electrically connected in series and/or in parallel with one another, wherein a battery module is respectively assigned a switching device such that the switching device is designed to electrically incorporate the respective battery module in the circuit of the battery system or to electrically exclude the respective battery module from the circuit of the battery system, wherein the battery system comprises a receptacle for an additional battery module, which receptacle is assigned a switching device such that the switching device is designed to electrically incorporate the additional battery module in the circuit of the battery system or to electrically exclude the additional battery module from the circuit of the battery system.

### BACKGROUND OF THE INVENTION

The invention is based on a battery system. The present invention also relates to a vehicle having such a battery system and to a method for operating a battery system.

The prior art discloses the fact that battery modules may comprise a plurality of individual battery cells which can be connected in series and/or in parallel with one another in an electrically conductive manner, with the result that the individual battery cells are interconnected to form the battery module.

Such battery modules are also interconnected to form batteries or battery systems.

Battery cells age over their service life and lose storage capacity, for example, in the process. The problem is that the aging behavior may be different from battery cell to battery cell. As a result, one battery cell of a battery module may have already reached the end of its service life, for example, while another battery cell of the battery module is still perfectly usable.

The end of the service life may be predefined, for example, by undershooting a critical minimum cell voltage or by an excessively low SOH (state of health) value.

Battery systems also usually comprise control devices which are designed to compensate for different cell voltages of the individual battery cells. As a result, it is possible to uniformly electrically discharge a battery module or a battery system. In particular, an aging behavior of the multiplicity of battery cells of a battery module is also intended to be adjusted thereby.

In addition to aging of the battery cells, individual cells may naturally also be defective, as a result of which the entire battery module would not be usable without a corresponding control device.

### SUMMARY OF THE INVENTION

A battery system having the features of the independent claim provides the advantage of enabling continued operation of a battery system having a defective or excessively aged battery module or a defective or excessively aged battery cell in a comparatively simple manner.

A battery system is provided for this purpose according to the invention. The battery system comprises a plurality of battery modules. In this case, the plurality of battery modules can be electrically connected in series and/or in parallel with one another in a circuit of the battery system.

The battery modules also each have a plurality of battery cells which are electrically connected in series and/or in parallel with one another.

A battery module is also respectively assigned a switching device such that the switching device is designed to electrically incorporate the respective battery module in the circuit of the battery system or to electrically exclude the respective battery module from the circuit of the battery system.

In this case, the battery system comprises a receptacle for an additional battery module. The receptacle is assigned a switching device such that the switching device is designed to electrically incorporate the additional battery module in the circuit of the battery system or to electrically exclude the additional battery module from the circuit of the battery system.

Advantageous developments and improvements of the apparatus stated in the independent claim are possible by virtue of the measures cited in the dependent claims.

The switching devices may be in the form of MOSFET switches, for example.

It is expedient if the additional battery module can be accommodated in the receptacle in a mechanically reversible manner. For this purpose, when the additional battery module is accommodated in the receptacle, a first electrical connection of the additional battery module can be connected to a first electrical connection of the receptacle in an electrically conductive manner and a second electrical connection of the additional battery module can be connected to a second electrical connection of the receptacle in an electrically conductive manner.

In other words, this means that an additional battery module can be inserted into the receptacle, for example. The receptacle already comprises the electrical connections for the additional battery module. As a result, it is possible to arrange the additional battery module in the battery system in a simple manner.

In particular, it is often difficult to replace a defective or excessively aged battery cell in a battery module. Furthermore, even the replacement of one battery module of the plurality of battery modules is comparatively complicated and, in particular, also expensive. The possibility of additionally arranging an entire battery module in the battery system, in particular in a mechanically reversible manner, makes it possible to provide a fast and comparatively cost-effective repair possibility.

It is advantageous if the switching device respectively comprises a first switching device and a second switching device.

In this case, the first switching device is designed to electrically incorporate the respective battery module in the circuit of the battery system or to electrically exclude the respective battery module from the circuit of the battery system. In this case, the second switching device is designed to close the circuit of the battery system when the respective battery module is excluded.

For example, the first switching device may be designed such that, in a closed state, the respective battery module is electrically incorporated in the circuit of the battery system and, in an open state, the respective battery module is electrically excluded from the circuit of the battery system.

For example, the second switching device may be arranged in a bypass path bypassing the respective battery module and may be designed such that, in an open state, a current flow through the bypass path is prevented and, in a closed state, a current flow through the bypass path is enabled.

In this case, it is preferred if, during fault-free operation of the respective battery module, the first switching device is arranged in a closed state and the second switching device is arranged in an open state.

In this case, it is preferred if, during faulty operation of the respective battery module, the first switching device is arranged in an open state and the second switching device is arranged in a closed state.

It is expedient if the battery system has a control device.

The control device preferably controls the respective switching device of the plurality of battery modules such that the respective battery module is excluded from the circuit of the battery system upon reaching a particular state of health or in the event of a defect. In particular, the first switching device may be arranged in an open state and the second switching device may be arranged in a closed state for this purpose.

In other words, the control device may exclude a faulty battery module from the circuit of the battery system.

The control device preferably controls the switching device of the receptacle such that an additional battery module accommodated in the receptacle is incorporated in the circuit of the battery system if a battery module of the plurality of battery modules is excluded from the circuit of the battery system.

In other words, the control device can incorporate an additional battery module in the circuit if another battery module is excluded.

In particular, the control device can also be designed according to embodiments known from the prior art such that different cell voltages of the individual battery cells of a battery module or different voltages of battery modules are compensated for. This makes it possible to compensate for different states of health.

In particular, it should be noted that the control device may be designed such that the control device monitors the plurality of battery modules and detects faulty battery modules. Faulty battery modules may have, for example, a battery cell with a critical minimum cell voltage below a predefined value or may have an excessively low SOH value. For example, battery systems may be designed such that they reach 8 years or 300,000 km or 15,000 operating hours, for example. For this purpose, the battery cells of a battery module are designed such that these goals can be achieved. On account of the reasons mentioned, such as in particular increased aging or a defect, it would not be possible to achieve these aims, for example.

Furthermore, the invention also relates to a vehicle which comprises a battery system according to the invention which has just been described. This provides the advantage that a comparatively fast and cost-effective possibility for continued operation of a battery system having a defective battery cell or a defective battery module is possible. In vehicles in particular, accessibility for repair in the event of a fault is possible only for trained expert personnel on account of an applied high voltage, for example. With an embodiment according to the invention of the battery system and, in particular, of the vehicle, an additional battery module can be arranged in the circuit of the battery system with comparatively few safety measures.

In particular, this provides the advantage that it is possible to also restore driving ability of the vehicle in the short term. For example, this makes it possible to look for the nearest workshop without the need for a breakdown service.

In this case, it is particularly preferred if the battery system is arranged in a vehicle floor. In this case, the receptacle may be designed as a type of opening, for example, which is easily accessible and in which an additional battery module can be arranged. In other words, this means that the receptacle may be designed as a type of empty box. It would preferably even be possible to provide a storage space in the receptacle or the empty box without the arrangement of the additional battery module.

In this case, the receptacle should be arranged in a manner easily accessible from an environment of the vehicle. For example, the receptacle may be closed by means of a closing device, for example a flap, for this purpose.

The present invention also relates to a method for operating a battery system.

The battery system is, in particular, a battery system according to the invention which has just been described and comprises a plurality of battery modules which can be electrically connected in series and/or in parallel with one another in a circuit of the battery system and each have a plurality of battery cells which are electrically connected in series and/or in parallel with one another. In this case, a battery module is respectively assigned a switching device. The switching device is used to electrically incorporate the respective battery module in the circuit of the battery system or to electrically exclude the respective battery module from the circuit of the battery system.

The battery system also comprises a receptacle for an additional battery module, which receptacle is assigned a switching device. The switching device is used to electrically incorporate the additional battery module in the circuit of the battery system or to electrically exclude the additional battery module from the circuit of the battery system.

It goes without saying that it is possible to advantageously develop the method according to the invention with any advantageous developments described in connection with the battery module according to the invention.

Overall, a battery system according to the invention or a method according to the invention provides the advantage that it is possible to extend the service life of the valuable components of an electrically driven vehicle or of a battery system, namely the battery modules.

A particular advantage is also the fact that the additional battery module can be arranged in the receptacle during the entire service life and is incorporated in the circuit of the battery system only if a faulty battery module of the plurality of battery modules occurs or that the additional battery module can be accommodated in the receptacle only if a faulty battery module of the plurality of battery modules occurs, in order to incorporate it in the circuit of the battery system.

In particular in vehicles in which fault tolerance must be paramount, for example autonomously operated vehicles, an arrangement of the additional battery module already in the new vehicle or at the beginning of a journey is useful. In the event of a fault, immobilization of the vehicle is therefore avoided since the defective battery module of the plurality of battery modules is automatically bridged and the additional battery module can be incorporated in the circuit of the battery system.

It is possible to use the battery system according to the invention or the method according to the invention in all types of electrically driven vehicles such as EV, PHEV, e-buses, e-shuttle or electrically driven working machines such as diggers and further construction machines or stationary battery-electric storage systems.

### BRIEF DESCRIPTION OF THE DRAWINGS

Exemplary embodiments of the invention are illustrated in the drawings and are explained in more detail in the following description.

In the drawings:

FIG. 1 schematically shows an illustration of a battery system according to the invention.

### DETAILED DESCRIPTION

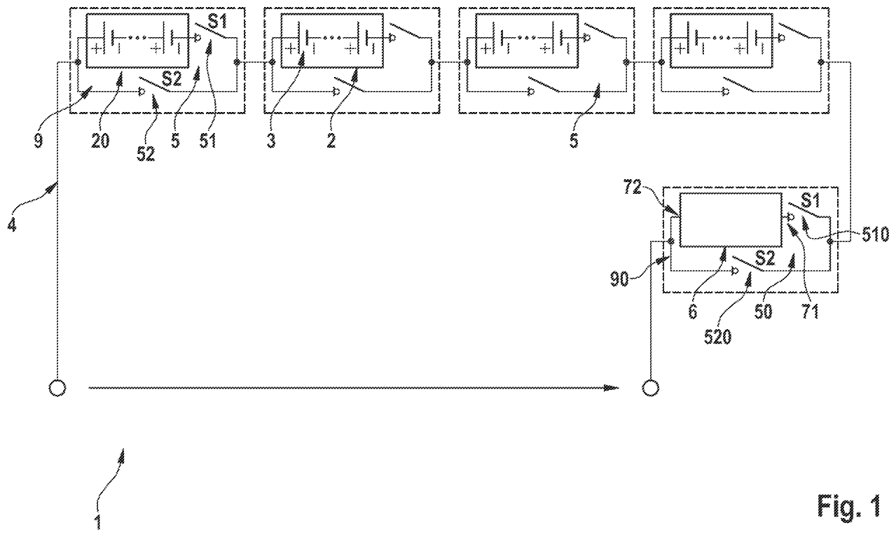

FIG. 1 schematically shows an illustration of a battery system 1 according to the invention.

The battery system 1 comprises a plurality of battery modules 2.

The plurality of battery modules 2 can be electrically connected in series and/or in parallel with one another in this case. Furthermore, each battery module 2 comprises a plurality of battery cells 3 which are electrically connected in series and/or in parallel with one another.

In this case, the plurality of battery modules 2 can be connected to one another in an electrically conductive manner in a circuit 4 of the battery system 1. In particular, the plurality of battery modules 2 can be electrically connected in series and/or in parallel with one another in the circuit 4 of the battery system 1.

Furthermore, it can be seen from FIG. 1 that the battery system 1 has a plurality of switching devices 5. In this case, each battery module 2 is assigned a switching device 5. The switching device 5 is designed in this case to electrically incorporate the respective battery module 2 in the circuit 4 of the battery system 1 or to electrically exclude the respective battery module 2 from the circuit 4 of the battery system 1.

For example, the switching device 5 has a first switching device 51 and a second switching device 52 for this purpose.

For example, an exemplary battery module 20 has such a first switching device 51 and such a second switching device 52.

In this case, the first switching device 51 is designed to electrically incorporate the respective battery module 2, for example the exemplary battery module 20, in the circuit 4 of the battery system 1 or to exclude the respective battery module 2, for example the exemplary battery module 20, from the circuit 4 of the battery system 1.

For example, the first switching device 51 of the exemplary battery module 20 can incorporate the exemplary battery module 20 in the circuit 4 of the battery system 1 in a closed state.

For example, the first switching device 51 of the exemplary battery module 20 can exclude the exemplary battery module 20 from the circuit 4 of the battery system 1 in an open state.

In this case, the second switching device 52 is designed to close the circuit 4 of the battery system 1 if the respective battery module 2, for example the exemplary battery module 20, is excluded from the circuit 4 of the battery system 1. In this case, the exemplary battery module 20 can be connected, in particular, by means of the first switching device 51. In particular, the second switching device 52 is arranged in a bypass pass 9 bypassing the respective battery module 2, for example the exemplary battery module 20.

If, for example, the first switching device 51 is open and the second switching device 52 is closed, current flows through the circuit 4 of the battery system 1 via the bypass path 9, and the respective battery module 2, for example the exemplary battery module 20, would be excluded from the circuit 4 of the battery system 1.

If, for example, the first switching device 51 is closed and the second switching device 52 is open, current flows through the circuit 4 of the battery system 1 via the respective battery module 2, for example the exemplary battery module 20, and the respective battery module 2, for example the exemplary battery module 20, would be incorporated in the circuit 4 of the battery system 1.

The battery system 1 also comprises a receptacle 6 for an additional battery module 21. It should be noted at this point that no additional battery module 21 is arranged in the receptacle 6 according to FIG. 1.

The receptacle 6 is designed such that the additional battery module 21 can be accommodated in the receptacle 6 in a mechanically reversible manner. In particular, when the additional battery module 21 is accommodated in the receptacle 6, a first electrical connection of the additional battery module 21 is connected to a first electrical connection 71 of the receptacle 6 in an electrically conductive manner and a second electrical connection of the additional battery module 21 is connected to a second electrical connection 72 of the receptacle 6 in an electrically conductive manner. In this case, the first connections may be positive connections, for example, and the second connections may be negative connections, for example.

In this case, the receptacle 6 is likewise assigned a switching device 50.

In this case, the switching device 50 is designed to electrically incorporate the additional battery module 21 in the circuit 4 of the battery system 1 or to electrically exclude the additional battery module 21 from the circuit 4 of the battery system 1.

In particular, the switching device 50 also comprises a first switching device 510 and a second switching device 520.

The switching device 50 is designed in this case to electrically incorporate the additional battery module 21 in the circuit 4 of the battery system 1 or to electrically exclude the additional battery module 21 from the circuit 4 of the battery system 1.

For example, the switching device 50 has a first switching device 510 and a second switching device 520 for this purpose. In this case, the first switching device 510 is designed to electrically incorporate the additional battery module 21 in the circuit 4 of the battery system 1 or to electrically exclude the additional battery module 21 from the circuit 4 of the battery system 1.

For example, the first switching device 510 of the additional battery module 21 can incorporate the additional battery module 21 in the circuit 4 of the battery system 1 in a closed state.

For example, the first switching device 510 of the additional battery module 21 can exclude the additional battery module 21 from the circuit 4 of the battery system 1 in an open state.

In this case, the second switching device 520 is designed to close the circuit 4 of the battery system 1 if the additional battery module 21 is excluded from the circuit 4 of the battery system 1. In this case, the additional battery module 21 can be excluded, in particular, by means of the first switching device 510. In particular, the second switching device 520 is arranged in a bypass path 90 bypassing the additional battery module 21.

If, for example, the first switching device 510 is open and the second switching device 520 is closed, current flows through the circuit 4 of the battery system 1 via the bypass path 90, and the additional battery module 21 is excluded from the circuit 4 of the battery system 1.

If, for example, the first switching device 510 is closed and the second switching device 520 is open, current flows through the circuit 4 of the battery system 1 via the additional battery module 21, and the additional battery module 21 is incorporated in the circuit 4 of the battery system 1.

The battery system 1 also comprises a control device 8 which cannot be seen in FIG. 1.

In this case, the control device 8 controls the respective switching device 5 of the plurality of battery modules 2 such that the respective battery module 2 is excluded from the circuit 4 of the battery system 1 upon reaching a particular state of health or in the event of a defect.

In this case, the control device 8 controls the switching device 50 of the receptacle 6 such that the additional battery module 21 is incorporated in the circuit 4 of the battery system 1 if a battery module 2 of the plurality of battery modules 2 is excluded from the circuit 4 of the battery system 1.

FIG. 1 shows a state in which the additional battery module 21 is excluded from the circuit 4 of the battery system 1.

In particular, which cannot be seen in FIG. 1, the battery system 1 is arranged in a vehicle 10. Furthermore, the battery system 1 can be arranged in a floor 11 of the vehicle 10.

1. A battery system comprising
a plurality of battery modules (2) which can be electrically connected in series and/or in parallel with one another in a circuit (4) of the battery system (1) and
each have a plurality of battery cells (3) which are electrically connected in series and/or in parallel with one another, wherein
a battery module (2) is respectively assigned a switching device (5) that is configured
to electrically incorporate the respective battery module (2) in the circuit (4) of the battery system (1) in a closed state, and
to electrically exclude the respective battery module (2) from the circuit (4) of the battery system (1) in an open state,
a receptacle (6) for an additional battery module (21), which receptacle is assigned a switching device (50) that is configured to
to electrically incorporate the additional battery module (21) in the circuit (4) of the battery system (1) in a closed stated, and
to electrically exclude the additional battery module (21) from the circuit (4) of the battery system (1).

2. The battery system according to the preceding claim 1,
wherein
the additional battery module (21) can be accommodated in the receptacle (6) in a mechanically reversible manner such that,
when the additional battery module (21) is accommodated in the receptacle (6),
a first electrical connection of the additional battery module (21) is connected to a first electrical connection (71) of the receptacle (6) in an electrically conductive manner and
a second electrical connection of the additional battery module (21) is connected to a second electrical connection (72) of the receptacle (6) in an electrically conductive manner.

3. The battery system according to claim 1,
wherein
the respective switching devices (5, 50) respectively comprises a first switching device (51, 510) and a second switching device (52, 520), wherein
the first switching device (51, 510) is configured
to electrically incorporate the respective battery module (2, 20, 21) in the circuit (4) of the battery system (1) in a closed state, and
to electrically exclude the respective battery module (2, 20, 21) from the circuit (4) of the battery system (1) in an open state, and
the second switching device (52, 520) is configured to close the circuit (4) of the battery system (1) when the respective battery module (2, 20, 21) is excluded.

4. The battery system according to claim 1,
wherein
a control device (8) controls the respective switching device (5) of the plurality of battery modules (2) such that
the respective battery module (2) is excluded from the circuit (4) of the battery system (1) upon reaching a state of health or in the event of a defect.

5. The battery system according to claim 1,
wherein
the control device (8) controls the switching device (50) of the receptacle (6) such that,
when a battery module (2) of the plurality of battery modules (20) is excluded from the circuit (4) of the battery system (1), an additional battery module (21) accommodated in the receptacle (6) is incorporated in the circuit (4) of the battery system (1).

6. A vehicle comprising a battery system (1) according to claim 1.

7. The vehicle according to claim 6,
wherein
the battery system (1) is arranged in a vehicle floor (11).

8. A method for operating a battery system (1) having a plurality of battery modules (2) which can be electrically connected in series and/or in parallel with one another in a circuit (4) of the battery system (1), wherein each have a plurality of battery cells (3) which are electrically connected in series and/or in parallel with one another and further having a receptacle for an additional battery module (21), the method comprising:
assigning at least one battery module (2) a switching device (5) such that
the switching device (5) electrically incorporates the respective battery module (2) in the circuit (4) of the battery system (1) when in a closed state electrically excludes the respective battery module (2) from the circuit (4) of the battery system (1) when in a closed state,
assigning the receptacle for an additional battery module (21) a switching device (50) such that
the switching device (50) electrically incorporates the additional battery module (21) in the circuit (4) of the battery system (1) when in a closed state and
electrically excludes the additional battery module (21) from the circuit (4) of the battery system (1) when in an open state.
